(19) United States
(12) Patent Application Publication
(10) Pub. No.: US 2025/0194615 A1
(43) Pub. Date: Jun. 19, 2025

(54) Processing of Fish Products

(71) Applicant: PURECUT TECHNOLOGIES AS, Hjelledalen (NO)

(72) Inventors: Olaf Brage MARVIK, Jar (NO); Kristian HORGEN, Manstad (NO); Eydun Karbech KJELD, Svenstrup (DK); Poul Møller NIELSEN, Svenstrup (DK)

(73) Assignee: PURECUT TECHNOLOGIES AS, Hjelledalen (NO)

(21) Appl. No.: 18/842,976

(22) PCT Filed: Mar. 2, 2023
(86) PCT No.: PCT/EP2023/055374

§ 371 Date: Aug. 30, 2024

(30) Foreign Application Priority Data
Mar. 2, 2022 (GB) 2202886.4

(51) Int. Cl. A22C 25/02

(52) U.S. Cl. CPC A22C 25/02

(57) ABSTRACT

An apparatus for processing of fish products comprising a descaling apparatus for removing scales from defleshed fish skin, the descaling apparatus comprising: a conveyor system for receiving defleshed fish skin, wherein the defleshed fish skin comprises skin and scales with a major part of the flesh removed; a fluid jetting system; a descaling surface for holding the defleshed fish skin with the scale side facing the fluid jetting system; wherein the fluid jetting system directs jets of fluid under pressure toward the defleshed fish skin with the jets configured to impact the defleshed fish skin at an angle, in order to thereby bend and detach the scales; and wherein the descaling surface and fluid jetting system are arranged for relative movement between the defleshed fish skin and the jets of fluid of the jetting system in order that the full area of the defleshed fish skin is exposed to the fluid jets.

The present invention relates to an apparatus for processing of fish products and to related methods for processing of fish products.

It is known to use machines for processing of fish in order to separate desired fish products from undesired fish products. Most often this has focused on obtaining high quality flesh, i.e. fillets of the fish, with the skins, bones and internal organs generally being removed and discarded. In some cases the skin is retained but scales are removed. In the case of processing of whole fish this has been done by means of water jets, e.g. as described in U.S. Pat. No. 5,183,679 concerning scale removal from frozen fish, or GB 518608 concerning jets used for fin removal and cleaning of the fish body cavity, as well as for scale removal. These processes then allow for scale free fish to be sold for food, often also with internal organs being removed by machine.

Separately, mechanisms have been developed for removal of the fish skin, e.g. via a precision knife, so that the defleshed fish skin can be discarded and the skin free flesh (the fillet), typically also deboned, has a higher value for food use.

Viewed from a first aspect, the invention provides an apparatus for processing of fish products comprising a descaling apparatus for removing scales from defleshed fish skin, the descaling apparatus comprising:
a conveyor system for receiving defleshed fish skin, wherein the defleshed fish skin comprises skin and scales with a major part of the flesh removed;
a fluid jetting system;
a descaling surface for holding the defleshed fish skin with the scale side facing the fluid jetting system;
wherein the fluid jetting system directs jets of fluid under pressure toward the defleshed fish skin with the jets configured to impact the defleshed fish skin at an angle, in order to thereby bend and detach the scales; and
wherein the descaling surface and fluid jetting system are arranged for relative movement between the defleshed fish skin and the jets of fluid of the jetting system in order that the full area of the defleshed fish skin is exposed to the fluid jets.

The inventors have realised that if it were possible to provide flat and scale free fish skins, with minimal flesh attached, then there are in fact beneficial uses for the skins. Thus, in contrast to discarding the skins, there can beneficially be added focus on retaining and isolating the fish skin from the scales. The inventors have also realised that a significant barrier for mechanical handling of fish skin is its lack of rigidity. Even with flesh attached the crude skin is very flexible, and it is difficult to keep it fixed in position during mechanical processing. Moreover, when the flesh is removed, the surface of the connective tissue is very sticky. Finding solutions to these practical problems are particularly exacerbated when implementing high-capacity continuous processing.

To achieve this the device of the first aspect uses a combination of features to first keep a defleshed fish skin fixed and suitably located, and to then allow scale removal whilst the skin is safely retained. It is not possible to perform these operations with known descalers since they are designed for use with whole fish, and often frozen fish, where the (frozen) body of the fish allows scales to be removed with a relatively aggressive process and absent any specialised device to keep the remainder of the fish in place. The defleshed fish skin may alternatively be termed a flat fish skin, though it will be appreciated that it need not necessarily be held in a flat plan but instead is flat in the sense of having a small thickness and being able to lay flat on a surface.

In some cases the descaled skin itself may be the end product, e.g. to be used in food such as sushi or as a material in place of other fine grade skin/leather type products. In that case suitable additional processing steps (e.g. conservation or tanning) may occur after the descaling. In other cases, the connective tissue core of the skin can be purified and used in food or in biomedicine applications (e.g. as a wound dressing). Alternatively and/or additionally, use can be made of material within the skins once it has been undergone different processing steps, including breaking down the structure of the skin, for example to refine and extract collagen or other materials. Further, the inventors have proposed a non-obvious combination of features, as in the first aspect above, enabling processing of fish skins already separated from the fish carcass, and with a major part of the flesh removed to remove unwanted scales, thereby giving a desired end product that cannot be obtained by the prior art devices discussed above.

Advantageously, the separated flesh and scales can also be used, so that nothing is wasted. Fish scales contain for instance chitin, which can be extracted to provide a beneficial by-product of the descaling process, such as by transforming the chitin into chitosan, which has multiple applications in biomedical and dietary products.

The by-product of a filleting process will in many cases be a skin with 2-5 mm flesh or more remaining on the skin, a so-called deep skinning process. Most of the remaining flesh can subsequently be removed with a suitably precise cutting device, resulting in what is referred to as a defleshed fish skin, comprising skin and scales with all or almost all flesh removed. Further features of an example cutting device are discussed below. The removal of a major part of the flesh may involve retaining a thickness of typically 3 mm or less for the defleshed fish skin. In some situations, the defleshed fish skins may be between 3.0 and 1.5 mm, or in some cases between 1.5 and 0.5 mm in thickness. In any case, the objective is to cut between and thus separate the muscle tissue from the connective tissue of the skin. The thickness of the connective tissue layers including scales may vary between different parts of the skin. For example, for salmon skin then the thickness after filleting and flesh removal may be in the range 1-2 mm. It will be understood that the optimal thickness of the defleshed fish skin will also vary depending on the species of fish, the health of the fish, the season during which the fish was caught and other variables. After descaling then the skin (along with the minor part of retained flesh) would be of a similar but slightly reduced thickness, having had the thickness of the scales removed.

The apparatus of the first aspect may hold the defleshed fish skin flat on the descaling surface, or it may follow a curve thereof. The descaling surface may be a conveying surface also forming a part of the conveyor system, such as a surface of a conveyor belt. Thus, the conveyor system may carry the defleshed fish skin to the fluid jetting system to enable the descaling step to occur, and it may then carry the descaled fish skin away from the fluid jetting system. Advantageously the movement of fish skin via the conveyor system may provide at least some of the relative movement of the fish skin and the fluid jetting system by passage of the fish skins past jets of the fluid jetting system.

The action of the jets of fluid can push the fish skin against the descaling surface and contribute to holding the fish skin in place during the descaling operation. The descaling surface may be a moving surface of the apparatus, and for example may be a part of the conveyor system as noted above. Movement of the descaling surface may allow for the defleshed fish skin to be located on the descaling surface and/or for the descaled fish skin to be removed from the descaling surface. For example, the descaling surface may be configured to receive the defleshed fish skin and optionally hold it in place during descaling (e.g. also creating movement of the skin relative to the fluid jetting system), before permitting or prompting detachment of the descaled and defleshed fish skin. In one example, as explained further below, the descaling surface may include spikes for piercing and hence gripping the skin. Other possibilities include vacuum systems, supporting meshes, freeze fixing surfaces (e.g. a super-cooled surface and/or principles used for freeze fixing handling devices as in U.S. Pat. No. 8,840,449), and so on.

With the use of spikes the descaling surface may be a conveyor surface of a spiked conveyor belt. A spiked descaling surface allows for picking up of the fish skin from a loading point, e.g. via transfer from another conveyor surface, and as there can be multiple spikes piercing the fish skin then this keeps the fish skin in place during action of the fluid jetting system. The spikes are particularly beneficial at holding the defleshed fish skin in place even during high conveyor speeds. The spikes will also advantageously provide support for the defleshed fish skins against the pressure exerted by the jets of fluid. The spikes therefore ensure secure and careful handling of the fish. The more spikes piercing the defleshed fish skin the lower the pressure experienced at each piercing site whilst supporting the defleshed fish skins against the pressure of the jets of fluid. After descaling via the action of the fluid jetting system then the descaled fish skin may be detached during further movement of the spiked conveyor belt with this further movement being configured to withdraw the spikes from the fish skin. This may be achieved by one or more of: curvature of the belt, withdrawal of the spikes from the surface of the belt; and/or a force urging the fish skin to detach from the spikes, such as via fluid pressure, gravity, or action of another release or outfeed mechanism (e.g. a transfer device, such as a scraper and/or brush or roller system as described below).

The spiked conveyor belt advantageously has spikes with a density and length configured for fully piercing the defleshed fish skins in multiple places for each defleshed fish skin. The spikes have an exposed length which is the length of the spike which protrudes from the descaling surface. The spikes may have an exposed length of more than the thickness of the defleshed fish skin, advantageously at least two times the thickness of the defleshed fish skin. Thus, the exposed length of the spikes may be 2 mm, or 3 mm or more, such as 4 mm or more or a length in the range 5 to 10 mm. It will be appreciated that the length may change depending on the expected thickness of the defleshed fish skin. The number of and density of the spikes may be sufficient to have at least 50 spikes in each defleshed fish skin on the descaling surface, optionally at least 100 spikes in each defleshed fish skin, optionally at least 200 spikes in each defleshed fish skin and may for example involve spikes of the spiked conveyor belt being at 3 cm spacing, or 2 cm spacing, or 1 cm spacing or less or at a value within the range 3 cm to 1 cm, giving a density of spikes of 1000 per m², or 2500 per m², or 10000 per m² or more, or a density within the range of 1000 per m² to 10000 per m². The distribution of the spikes may be uniform over the descaling surface or may vary across the descaling surface. The spike density and distribution can be tailored in view of the requirements of the defleshed fish skin being processed and the pressure of the fluid jets. For smaller fish skin the number of spikes may be correspondingly fewer.

The spikes are advantageously thin, for example with a diameter/thickness between 0.1 and 1 mm, in order to reduce the damage to the skin of the defleshed fish skin as a result of the spikes piercing the skin. The spikes may have a circular cross section, which may have benefits for ease of manufacture as well as to avoid sharp angles that may increase the risk of tearing the fish skin.

The descaling surface, optionally as a descaling conveyor that may be within the conveyor system, is optionally configured so that the exposed surface of the fish skin faces downward in the direction of gravity. Thus, the defleshed fish skin may be held on the descaling surface with the scaled surface facing downward, i.e. facing in a direction with a downward extent such as being perpendicular to the direction of gravity, or angled thereto but generally downwards. In this case the fluid jetting system should be arranged to direct the jets of fluid in an upward direction, such as an upward direction that is also diagonally angled as discussed in further detail below. This configuration allows for the fluid and scales to fall away from the fish skin during the descaling process, which avoids build-up of fluid and scales on top of the descaling surface and/or on top of the fish skin during processing.

The descaling apparatus may comprise a retention device for preventing the fish skins from detaching from the descaling surface during the descaling process. In the case of a downward facing descaling surface the retention device may extend parallel to the descaling surface just below the descaling surface so that a fish skin cannot fall away from the descaling surface without being caught by the retention device. Thus, there may be a gap between the descaling surface and the retention device. This gap may in some cases be larger than the thickness of the defleshed fish skins. . . . In other cases, the gap may be slightly smaller than the thickness of the defleshed fish skins in order to compress them against the descaling surface. It will be appreciated that the gap thickness may be set dependent on the relevant dimensions for the fish skin that is being processed, and/or the defleshed fish skins may be provided with a range of thickness or maximum thickness that is matched to the gap (e.g. by appropriate configuration of a cutting device, as discussed below).

Thus, in general terms, the gap between the descaling surface and the retention device is preferably wide enough to allow for the free passage of the defleshed fish skin attached to the spikes, while at the same time sufficiently narrow to keep the skin substantially horizontal and restrain the skin edge from curling up due to the forward movement and/or the action of the fluid jets. It is advantageous if the descaling surface exerts a mild downward pressure onto the skin as it is transported along the retention device. Thus in some examples this may be achieved by making the gap slightly smaller than the thickness of the defleshed fish skin and/or by allowing the descaling surface to deform, e.g. under gravity, to press toward the retention device. A small gap width may be particularly critical at the entry point where the skin becomes attached to descaling surface, such as via attachment to the spikes where present. At this attachment site it is beneficial that the spikes are longer than the gap width to make sure that the spikes fully penetrate the skin.

In examples where the gap is bigger than the thickness of the defleshed fish skins then the gap may advantageously be no more than twice the maximum thickness of the defleshed fish skins, or no more than 50% greater than the maximum thickness of the defleshed fish skins.

Where a spiked belt is used then the gap may advantageously be small enough such that the spikes of the descaling surface remain at least partly within the defleshed fish skin even if the skin was to rest on the retention device. Thus, the apparatus may be configured so that the gap is smaller than the spike length. This can ensure that the conveying motion is transferred to the defleshed fish skin even whilst the defleshed fish skin rests on the retention device.

Where the gap is the same as or smaller than the thickness of the defleshed fish skins then this gap may be present only when the apparatus is in use, i.e. the presence of the defleshed fish skins on the descaling surface may act to move the descaling surface away from the retention device (or vice versa) so that the gap opened only by the required amount to fit the defleshed fish skins. The descaling surface and/or the retention device may be movable using a manual or automatic mechanism, such as a lever actuated mechanism, in order to bring the descaling surface close to the retention device prior to use, such as by lowering it toward the retention device. In some examples a resilient mechanism, e.g. using spring devices, may be provided to allow this relative movement of the descaling surface and the retention device in order to maintain a minimum compressive force on the defleshed fish skins whilst permitting the gap to open to a suitable size.

The retention device may be a grill such as a lamella plate, which may for example comprise multiple parallel rods allowing for the jets of fluid to pass through toward the descaling surface, but preventing the fish skins from detaching. The parallel rods may extend in the direction of the relative movement of the descaling surface and the fluid jetting system. Advantageously, such a grill of parallel rods can be combined with a spiked conveyor, wherein the openings between the parallel rods permit the spikes to extend beyond the grill whilst being able to freely move along the length of the grill. The spikes may protrude from the descaling surface to have an exposed minimum length allowing them to penetrate the defleshed fish skin and extend fully across the gap between the descaling surface and the retention device. Typically, the spikes may have a length of 2-10 mm, or preferably 5-10 mm, 6-8 mm or 4-7 mm. The parallel rods may extend parallel with the direction of movement of the spikes.

The apparatus uses angled jets to remove the scales. The jets are arranged to provide an angular force attacking the free end of the scale (i.e. the end of the scale which is not attached to the skin). The angular force is neither parallel to the defleshed fish skin, or perpendicular to the defleshed fish skin. The angled jets are advantageously angled to push the scales away from the skin surface, i.e. to push them at an angle to the surface of the defleshed fish skin with the jet directed toward the head from the tail end. The leading angle of attack of the jets will result from the combined effect of the angle of the nozzle and the spray angle of the water jet. For example, if the nozzle is angled 10 degrees from the vertical and the spray angle has a spread of 20 degrees from the centre line of the nozzle, to either side of the nozzle then the maximum angle of the leading part of the jet directed toward the approaching defleshed fish skin would be 30 degrees relative to the vertical and 60 degrees relative to a horizontal plane parallel to the descaling surface. Optionally, the maximum leading angle of the jet may be configured to be at 10 to 70 degrees to the vertical, such as 20-60 degrees to the vertical or more preferably 25-40 degrees to the vertical. By way of further examples, a jet with a leading angle of the jet of 30 degrees may be achieved by a jet nozzle with centre line angled at 15 degrees with a jet spread of ±15 degrees about the centre line, or by a jet nozzle with centre line angled at 20 degrees and a jet spread of ±10 degrees about the centre line.

Other parts of the jet spray would naturally hit the surface of the defleshed fish skin at different angles, typically with a circular jet having an elliptical impact pattern. This would include parts of the spray directed laterally or even slightly backwards. While possibly being less effective in breaking the scales loose, these parts of the jet spray may rinse away partly detached scales and maintain an upward pressure on the skin supporting its horizontally flat position and continued attachment to the spikes.

The angle of the angled jet may be measured based on the centre line of the fluid emitted as the jet. The angled jets may be provided by angled nozzles. The defleshed fish skins and the angled jets move relative to one another, e.g. by motion of the defleshed fish skin whilst the jets remain fixed in place, or vice versa. The defleshed fish skin may be moved relative to the angled jets in a tail first direction, so that the jets are angled with the jet angle including a component against the direction of relative movement, e.g. against the direction of movement of the defleshed fish skin, and directed toward the head end of the fish skin.

Advantageously, the angled jets may be configured to provide a rotating jet of fluid, e.g. a rotation of the jet that is driven by the fluid pressure. The angled jets of fluid may rotate with an axis of rotation parallel to the direction of the jet. Rotating or oscillating jets will create a set of differently angled and pulsing shear forces, which may aid in removal of the scales. It may allow for a lower pressure to be used whilst maintaining the efficiency of the scale removal process.

In some examples, the pressure from the fluid jets may provide sufficient force to keep the defleshed fish skin retained within the spikes of the descaling surface, and thus retained against the descaling surface, without the need for a retention device.

There are multiple angled jets of fluid, and the fluid jetting system may be configured to provide multiple jets in a staggered pattern across the defleshed fish skin. For example, there may be multiple rows of jets, where a first row has jets that are offset in position from a second row.

There may be a reservoir for receiving the detached scales along with fluid from the jets after impaction on the descaling surface and/or fish skin. The reservoir may be arranged for separation of the scales from the fluid, e.g. to allow for the fluid to be circulated back to the jets. There may be a sieving and/or filtering system to ensure a suitably clean fluid is recirculated. The scales can be collected and used as an added product of the apparatus. Advantageously, where the descaling surface faces downward and the fluid jetting system directs the fluid jets upward then the reservoir may be located directly below the descaling surface, for example below the fluid jetting system, in order that the detached scales as well as fluid from the jets falls downward from the descaling surface into the reservoir.

The descaling apparatus may be enclosed, for example to prevent unwanted dispersal of fluid or parts of fish during use. Thus, there may be a housing surrounding the descaling apparatus. The housing may have openings for movement of the defleshed fish skin and descaled fish skin along the conveyor system in/out of the descaling process. The reservoir may be provided at the base of the housing.

The conveyor system may be configured such that the defleshed fish skin is in a consistent position relative to the jets of the fluid jetting system, in order to allow for a consistent descaling effect. It will of course be appreciated that the defleshed fish skins are a natural product with consequent variation in size, shape and other parameters, e.g. flexibility, and therefore some variation in positioning may be expected as a consequence. The apparatus may be provided with sensors for determining the location and/or orientation of the defleshed fish skin at one or more points, for example a location and/or orientation of the defleshed fish skin on the descaling surface, and operation of the apparatus may be modified in reaction to the determined location and/or orientation. Alternatively, or additionally, the apparatus may include an alert system for notifying the operator if the determined location and/or orientation is not within preset limits. One possible configuration advantageously includes an automated system for controlling the relative movement and/or location of the defleshed fish skin and the fluid jetting system in order to align and optimise the location of the fish skin with the angled jets. For example, this may be done by lateral and/or angular movement of the jetting system relative to extent of the defleshed fish skin along the descaling surface.

The apparatus may be provided with sensors for determining the presence of defleshed fish skin on the descaling surface and/or passing the jetting system. The operation of the jetting system may be limited to times when the sensors have detected the presence of a defleshed fish skin on the descaling surface and/or passing the jetting system. This will reduce water and energy consumption compared to having the jetting system continuously operating. Sensors may be employed which can provide both a determination of fish skin presence and a determination of location and/or orientation.

The apparatus for processing of fish products may optionally comprise apparatus suitable for flattening the defleshed fish skin. The apparatus for flattening the defleshed fish skin may be disposed ahead of the conveyor system of the descaling apparatus so that the defleshed fish skin is flattened before it attaches to the descaling surface. Thus, the apparatus for flattening defleshed fish skin may be disposed adjacent the entry end of the conveyor system of the descaling apparatus. The apparatus for flattening the skin may comprise a flattening surface and a device for applying pressure. The device for applying pressure may be a scraper or roller. By scraper it is meant a piece operable to engage the defleshed fish skin. A surface of the scraper or roller that is configured to contact the defleshed fish skin may be separated from the flattening surface at a distance suitable to allow the defleshed fish skin to pass through whilst any curls or buckles in the defleshed fish skin are removed due to pressure from the scraper or roller and the flattening surface. The distance between the scraper or roller and the flattening surface may be adjustable to an appropriate distance depending on the incoming defleshed fish skin to account for variations in the thickness of defleshed fish skins within a batch of defleshed fish skins or between batches of defleshed fish skins. The scraper or roller may be disposed such that a longitudinal direction of the scraper or roller is perpendicular to the direction of movement of the conveyor system. The device for applying pressure may alternatively or additionally comprise a second fluid jetting system disposed above the flattening surface such that jets of fluid are directed towards the defleshed fish skin advantageously at an angle that causes the defleshed fish skin to flatten against the flattening surface.

The apparatus for processing of fish products may optionally comprise an automated system for sorting and discarding damaged or unsuitable defleshed fish skins so that such damaged or unsuitable defleshed fish skins do not enter the descaling apparatus.

The apparatus may include a release mechanism for removing the defleshed fish skin from the descaling surface, the release mechanism may for example include a scraper, and a brush or roller. The release mechanism may be disposed at the exit end of the conveyor system comprising the descaling surface to remove the defleshed fish skin once it has passed over the jetting system and the scales have been removed. The release mechanism may also assist in guiding the defleshed fish skin to a further processing component. The scraper presses against the descaling surface to depress the descaling surface and cause separation between the descaling surface and the descaled defleshed fish skin. A brush or roller may rotate and contact the defleshed fish skin which correspondingly aids in removing the defleshed fish skin from the descaling surface. The release mechanism will aid in careful handling of the defleshed fish skin.

As noted above the descaling apparatus is for removing scales from defleshed fish skins and the defleshed fish skin may be obtained via first filleting a whole fish creating a skin by-product typically with considerable flesh still remaining attached to the skin. The skin by-product may thus comprise a major portion of flesh. The amount of flesh remaining will depend on the fillet process. In cases where it is necessary to remove flesh from the skin by-product of a filleting process, the descaling apparatus may advantageously be combined with a cutting device for removing this remaining flesh, thus creating a defleshed fish skin. In particular there may be a combined system where the defleshed fish skins are conveyed directly from the cutting device to the descaling apparatus. This provides a continuous process for taking fish fillets and producing separated flesh, scale and skin products.

Thus, viewed from another aspect, for fish skin having significant flesh attached the invention provides an apparatus for processing of fish products comprising: a cutting device for receiving fish skin with attached flesh and for removing a major portion of the flesh to provide defleshed fish skins; and a descaling apparatus as described above; wherein the apparatus is arranged to convey the defleshed fish skins from the cutting device to the conveyor system of the descaling apparatus. The conveyor system of the descaling apparatus may hence couple to a conveyor system of the cutting device. Accordingly, the inventors have proposed a non-obvious combination of steps, to enabling processing of fish skins separated from the fish carcass, for instance the skin by-product of a filleting process, to remove unwanted scales and remaining flesh, thereby giving a desired end product that cannot be obtained by the prior art methods discussed above.

The cutting device may comprise a cutter conveyor belt and a knife placed with its cutting edge extending across the width of the cutter conveyor belt and perpendicular to the direction of movement of the conveyor belt. When a fish skin with considerable flesh remaining (such as an intact fillet or the product of a deep skinning process described above) is placed on the cutter conveyor belt with the skin side contacting the belt surface, and then is moved along past the knife by movement of the cutter conveyor belt then the knife acts to slice off most of the remaining flesh leaving a defleshed fish skin. The knife may be located with the entire length of the cutting edge spaced apart from the surface of the cutter conveyor belt by a distance of 3 mm or less, or optionally 2 mm or less in order to separate the muscle tissue from the connective tissue of the skin, thus providing an essentially defleshed fish skin of corresponding thickness of 3 mm or less, or 2 mm or less. The length of the cutting edge may be parallel with the conveyor belt surface so that the distance between the cutting edge and the conveyer belt is constant.

The cutting device may be connected to the descaling apparatus via a handling system for moving the defleshed fish skin from the cutter conveyor belt to the descaling surface. The handling system may connect with and work together with the conveyor system of the descaling apparatus. The apparatus for flattening the defleshed fish skin may be provided in combination with the cutting device and handling system. The defleshed fish skin is moved by the handling system from a position with skin side contacting the cutter conveyor belt surface to a position with the skin side facing away from the descaling surface. In examples comprising an automated system for sorting and discarding damaged or unsuitable defleshed fish skins, the cutting device may be connected to the descaling apparatus via the handling system and the automated system for sorting and discarding damaged or unsuitable defleshed fish skins.

Viewed from another aspect, the invention provides a method for processing of fish products comprising using a descaling apparatus for removing scales from defleshed fish skin, optionally by using a descaling apparatus as described above. In one example the descaling apparatus comprises: a conveyor system for receiving defleshed fish skin, wherein the defleshed fish skin comprises skin and scales with a major part of the flesh removed, a fluid jetting system, and a descaling surface for holding the defleshed fish skin with the scale side facing the fluid jetting system; and the method comprises:
receiving defleshed fish skin at the conveyor system and conveying it to the descaling surface;
directing jets of fluid under pressure from the fluid jetting system toward the defleshed fish skin with the jets configured to impact the defleshed fish skin at an angle, in order to thereby bend and detach the scales; and
moving the defleshed fish skin relative to the fluid jetting system in order that the full area of the defleshed fish skin is exposed to the fluid jets.

The jets of fluid may be configured to detach the scales by bending the scales and breaking the scales loose from their scale pocket of the dermis tissue layer.

The method first keeps a defleshed fish skin fixed and suitably located, and then allows scale removal whilst the skin is safely retained. It is not possible to perform these operations with known methods since they are designed for use with whole fish, and often frozen fish, where the (frozen) body of the fish allows scales to be removed with a relatively aggressive process and absent any specialised steps to keep the remainder of the fish in place. The defleshed fish skin may alternatively be termed flat fish skin, though it will be appreciated that it need not necessarily be held in a flat plane but instead is flat in the sense of having a small thickness and being able to lay flat on a surface.

In some cases the descaled skin itself may be the end product, e.g. for use in place of other fine grade skin/leather type products. In that case suitable additional processing steps (e.g. tanning) may occur after the descaling. In other cases, the connective tissue core of the skin can be purified and used in food or in biomedicine applications (e.g. as a wound dressing). Alternatively and/or additionally, use can be made of material within the skins once it has been undergone different processing steps, including breaking down the structure of the skin, for example to refine and extract collagen or other materials. Further, the inventors have proposed a non-obvious combination of steps, as in the aspect of the invention above, enabling processing of fish skins separated from the fish carcass, with a major part of the flesh removed to remove unwanted scales, thereby giving a desired end product that cannot be obtained by the prior art methods discussed above.

Advantageously, the separated flesh and scales can also be used, so that nothing is wasted. Fish scales contain useful compounds such as chitin, which can be extracted to provide a beneficial by-product of the descaling process, such as by transforming the chitin into chitosan, which has multiple applications in biomedical and dietary products.

The by-product of a so-called deep skinning fillet generating process will in many cases be a skin with 2-5 mm flesh or more remaining on the skin. A suitably precise cutting device may then be used in order to remove the remaining part of the flesh from the skin/scales, arriving at the defleshed fish skin. Further features of the steps to provide the defleshed fish skin are discussed below. The defleshed fish skin may typically have a thickness of 3 mm or 2 mm or less. In some situations, the defleshed fish skins may be between 1.0-0.5 mm in thickness. It will be understood that the thickness of the defleshed fish skin will vary depending on the species of fish, the health of the fish, the season during which the fish was caught and other variables. After descaling, then the skin would be of a similar but slightly reduced thickness, having had the thickness of the scales removed. Accordingly, the inventors have proposed a non-obvious combination of features, to enable processing of fish skins separated from the fish carcass, for instance the skin by-product of a filleting process, to remove unwanted scales and remaining flesh, thereby giving a desired end product that cannot be obtained by the prior art devices discussed above.

It should be appreciated that the descaling apparatus may of course also be used to process already defleshed fish skin, for instance if the filleting process is not a deep skinning process but a process cutting the fillet tightly to the inner skin surface.

The defleshed fish skin may be held flat on the descaling surface, or it may follow a curve thereof. The descaling surface may be a conveying surface also forming a part of the conveyor system, such as a surface of a conveyor belt. Thus, the method may include conveying the descaling surface as part of the conveyor system in order to move the defleshed fish skin relative to the fluid jetting system. The defleshed fish skin may be carried to the fluid jetting system by the conveyor system to enable the descaling step to occur, and the defleshed fish skin may then be carried away from the fluid jetting system by conveyor system. Advantageously the movement of fish skin via the conveyor system may provide at least some of the relative movement of the fish skin and the fluid jetting system by passage of the fish skins past jets of the fluid jetting system.

The defleshed fish skin may be held in place via the action of the jets of fluid pushing the defleshed fish skin against the descaling surface and so the action of the jets of fluid may contribute to holding the fish skin in place during the descaling operation. Movement of the descaling surface may allow for the defleshed fish skin to be located on the descaling surface and/or for the descaled fish skin to be removed from the descaling surface. For example, the descaling surface may receive the defleshed fish skin and optionally hold it in place during descaling (e.g. also creating movement of the skin relative to the fluid jetting system), before permitting or prompting detachment of the descaled and defleshed fish skin.

The method may include holding the defleshed fish skin against the descaling surface using spikes which protrude from the descaling surface and pierce the defleshed fish skin in order to grip the defleshed fish skin. The spikes may protrude from the descaling surface to have an exposed minimum length allowing them to penetrate the defleshed fish skin, and extend fully across the gap between the descaling surface and the retention device. Typically, the spikes will have a length of 2-10 mm or preferably 4-7 mm. Other possibilities include holding the defleshed fish skin against the descaling surface using vacuum systems, supporting meshes, freeze fixing surfaces (e.g. a supercooled surface and/or principles used for freeze fixing handling devices as in U.S. Pat. No. 8,840,449), and so on.

A spiked descaling surface allows for picking up of the fish skin from a loading point, e.g. via transfer from another conveyor surface, and as there can be multiple spikes piercing the fish skin then this keeps the fish skin in place during action of the fluid jetting system. The spikes are particularly beneficial at holding the defleshed fish skin in place even during high conveyor speeds. The spikes will also advantageously provide support for the defleshed fish skins against the pressure exerted by the jets of fluid. The spikes therefore ensure secure and careful handling of the fish. The more spikes piercing the defleshed fish skin the lower the pressure experienced at each piercing site whilst supporting the defleshed fish skins against the pressure of the jets of fluid.

After descaling via the action of the fluid jetting system then the descaled fish skin may be detached during further movement of the spiked conveyor belt wherein the spikes are withdrawn from the fish skin. This may be achieved by one or more of: curvature of the belt, withdrawal of the spikes from the surface of the belt; and/or a force urging the fish skin to detach from the spikes, such as via fluid pressure, gravity, or action of another release/outfeed mechanism (e.g. a transfer device, such as a scraper, guides and/or brush or roller system as described below).

The defleshed fish skin may advantageously be fully pierced by spikes in multiple places. The method may include piercing the defleshed fish skin with at least 50 spikes, optionally at least 100 spikes in each defleshed fish skin, optionally at least 200 spikes in each defleshed fish skin and may for example involve piecing the defleshed fish skin with spikes having a 3 cm spacing, or 2 cm spacing or 1 cm spacing or less, or at a value within the range 3 cm to 1 cm, giving a density of spikes of 1000 per m² or 2500 per m² or 10000 per m² or more. Spikes may pierce the defleshed fish skin in a uniform, or non-uniform pattern. The density and distribution of the spikes can be tailored in view of the size and other requirements of the defleshed fish skin being processed and the pressure of the fluid jets.

The spikes are advantageously thin, for example with a thickness or diameter between 0.1 and 1 mm, in order to reduce the damage to the skin of the defleshed fish skin as a result of the spikes penetrating the skin. The spikes may have a circular cross-section as discussed above.

The method may include holding the defleshed fish skin against the descaling surface such that the exposed surface of the fish skin faces in a downward direction, and directing the jets of fluid in an upward direction, angled toward the surface of the defleshed fish skin.

Thus, the defleshed fish skin may be held on the descaling surface with the scaled surface facing downward, i.e. facing in a direction with a downward extent such as being perpendicular to the direction of gravity, or angled thereto but generally downwards. In this case the fluid jetting system directs the jets of fluid in an upward direction, such as an upward direction that is also diagonally angled as discussed in further detail below. This configuration allows for the fluid and scales to fall away from the fish skin during the descaling process, which avoids build-up of fluid and scales on top of the descaling surface and/or on top of the fish skin during processing.

The method may include preventing the defleshed fish skin from detaching from the descaling surface during the descaling process using a retention device.

The method may include providing the retention device to extend parallel to the descaling surface and below the descaling surface so that the defleshed fish skin cannot fall away from the descaling surface without being caught be the retention device. The method may include providing the retention device such that there is a gap as discussed above. The method may include providing the retention device in the form of a grill comprising multiple parallel rods allowing for the jets of fluid to pass through the retention device toward the descaling surface, but preventing the defleshed fish skins from detaching from the descaling surface during the descaling process. This retention device may have features as discussed above.

Advantageously, such a grill of parallel rods can be used with a spiked conveyor, wherein the openings between the parallel rods permit the spikes to extend beyond the grill whilst being able to freely move along the length of the grill. In this case the gap between the grill and the descaling surface may be less than the exposed length of the spikes and more than the maximum thickness of the defleshed fish skins. The parallel rods may be provided to extent parallel with the direction of movement of the spikes.

The method may include directing angled jets of fluid at the defleshed fish skin to remove the scales. The jets provide an angular force for attacking the free end of the scale (i.e. the end of the scale which is not attached to the skin). The angular force is neither parallel to the defleshed fish skin, or perpendicular to the defleshed fish skin.

These angled jets are advantageously directed to push the scales away from the skin surface, i.e. to push them at an angle to the surface of the defleshed fish skin with the jet directed toward the head from the tail end.

The angled jets may be angled to the vertical as discussed above, in order to impact the scales in a way that prompts their removal.

The defleshed fish skins and the angled jets move relative to one another, e.g. by motion of the defleshed fish skin whilst the jets remain fixed in place. The defleshed fish skin may move relative to the angled jets in a tail first direction, so that the jets are directed at the defleshed fish skin with an angle which includes a component against the direction of relative movement, e.g. against the direction of movement of the defleshed fish skin, and directed toward the head end of the fish skin.

The angled jets may provide a rotating jet of fluid, e.g. a rotation of the jet that is driven by the fluid pressure. The angled jets of fluid may rotate with an axis of rotation parallel to the direction of the jet. Rotating fluid jets may be used to create differently angled and pulsing shear forces which may aid in the removal of the scales. Using rotating fluid jets may allow for a lower pressure to be used whilst maintaining the efficiency of the scale removal process, thus a gentler scale removal process can be achieved.

Multiple angled jets of fluid may be directed at the defleshed fish skin, and they may contact the defleshed fish skin in a staggered pattern across the defleshed fish skin. For example, at a given time there may be multiple jets contacting the defleshed fish skin in a pattern comprising rows of contact points, where a first row of contact points are offset in position from a second row.

The method may include receiving, in a reservoir, detached scales along with the fluid from the jets of fluid after impaction on the descaling surface and/or defleshed fish skin.

The reservoir may separate the scales from the fluid, e.g. to allow for the fluid to be circulated back to the jets. The scales and fluid may be sieved and/or filtered to ensure a suitably clean fluid is recirculated to the fluid jetting system. The scales can be collected and used as an added product of the apparatus. Advantageously, where the descaling surface faces downward and the fluid jetting system directs the fluid jets upward then the reservoir may collect the scales and fluid directly below the descaling surface, for example below the fluid jetting system, in order that the detached scales as well as fluid from the jets falls downward from the descaling surface into the reservoir.

The method may include determining the location and/or orientation of the defleshed fish skin at one or more points using sensors. The method may include automatically modifying the conveyor system and/or the jets of fluid in response to the determined location and/or orientation. Alternatively, the method may include alerting an operator if the determined location and/or orientation is not within preset limits.

The method may include automatically controlling the relative movement of the defleshed fish skin and the fluid jetting system in order to align and optimise the location of the fish skin with the location and direction of the angled jets.

The method may include receiving the by-product of the fish filleting process. If there are considerable flesh remaining attached to the skin, for instance following a so-called deep skinning process, a cutting device may be used to remove most of the remaining flesh in order to provide the defleshed fish skins, and conveying the defleshed fish skins from the cutting device to the conveyor system. With this method a continuous process for taking fish fillets and producing separated flesh, scale and skin products is achieved. The method may include providing the cutter device comprising a knife and a cutter conveyor belt, and placing the knife with its cutting edge extending across the width of the conveyor belt of the cutter device, so that the width of the knife extends parallel to the surface of the cutter conveyor belt. When a fish fillet or the product of a deep skinning process as described above, is placed on the cutter conveyor belt with the skin side contacting the belt surface, and then is moved along past the knife by movement of the cutter conveyor belt, then the knife acts to slice off a major part of the remaining flesh leaving a defleshed fish skin. The method may include providing the knife with the cutting edge spaced apart from the surface of the cutter conveyor belt by a distance of 3 mm or less, or optionally 2 mm or less depending on the thickness of the connective tissue layer of the skin.

The method may include use of a handling system to move the defleshed fish skin from the cutter conveyor belt to the descaling surface. The defleshed fish skin is moved by the handling system from a position with skin side contacting the cutter conveyor belt surface to a position with the skin side facing away from the descaling surface.

The method may include use of an automated sorting and discharging system to avoid damaged or unsuitable skins entering the descaling apparatus.

The method may include the use of apparatus for flattening the defleshed fish skin so that any curls or buckles of the defleshed fish skin are removed before the defleshed fish skin is received by the descaling surface.

The method may comprise determining the presence of defleshed fish skin on the descaling surface and/or passing the jetting system using sensors. The method may comprise limiting the operation of the jetting system to times when the presence of a defleshed fish skin on the descaling surface and/or passing the jetting system has been detected. This will reduce water and energy consumption compared to having the jetting system continuously operating.

The method may comprise determining the presence, location and/or orientation of the defleshed fish skin using the same sensor.

The method may comprise removing the defleshed fish skin from the descaling surface using a release mechanism, for example a scraper and a brush and/or roller. The defleshed fish skin may be removed from the descaling surface after the descaling process has taken place, and hence after the defleshed fish skin has passed over the fluid jetting system. The release mechanism may also assist in guiding the defleshed fish skin to a further processing component. The scraper presses against the descaling surface to depress the descaling surface and cause separation between the descaling surface and the descaled defleshed fish skin. A brush or roller may rotate and contact the defleshed fish skin which correspondingly aids in removing the defleshed fish skin from the descaling surface.

The brush may be between 40-100 mm in diameter and positioned tangent to the descaling surface. The intersection of the centre of the brush and the centre of the radius of curvature of the exit end of the conveyor system may form an angle of 30-60 degrees to the vertical.

Additionally or alternatively, the release mechanism may include a skin release fluid jetting system configured so that fluid under pressure is directed towards the descaled defleshed fish skin at an angle aiding the removal of the descaled defleshed fish skin from the descaling surface.

Guides may be provided to guide the descaled defleshed fish skin away from the descaling surface. The guides may be shaped so as to force the skin away from the descaling surface, and detaching the skin from the spikes thus preventing the descaled defleshed fish skin from being retained against the conveyor system as the belt moves around the exit end and to the upper surface.

These guides may be static and may be suspended in position via a suitable support or may be attached to the conveyer system. In cases where the guides are attached to the conveyor system, the descaling surface is split into two or more parallel sections such that the guides are accommodated within each of the one or more gaps between the parallel sections.

The release mechanism will aid in careful handling of the defleshed fish skin.

Certain preferred embodiments will now be described by way of example only and with reference to the Figures, in which:

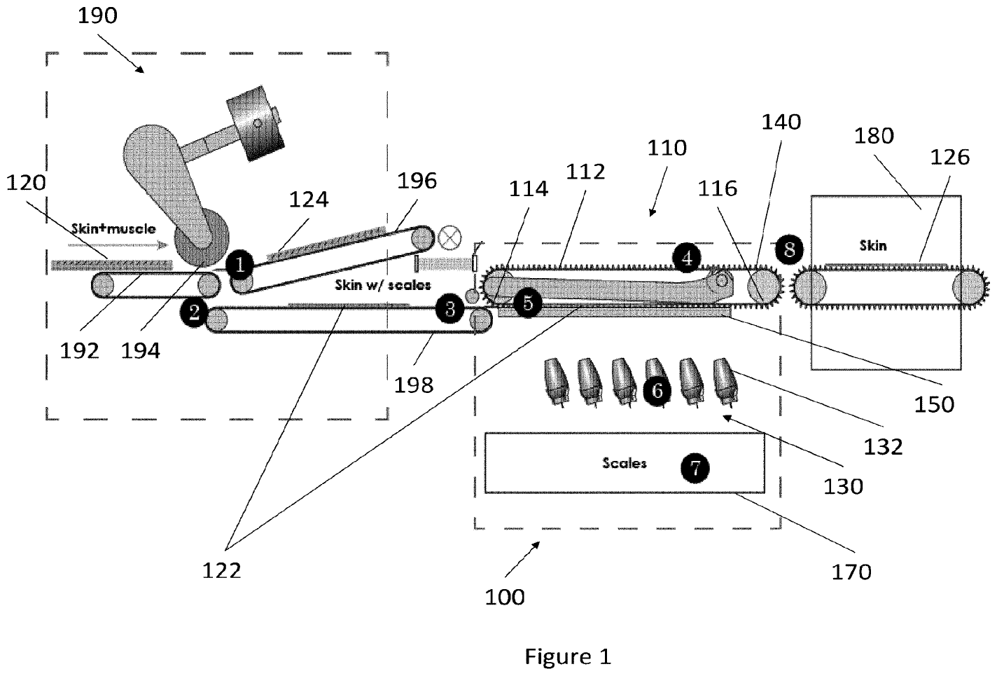

FIG. 1 shows a schematic of an apparatus for removing scales from defleshed fish skin;

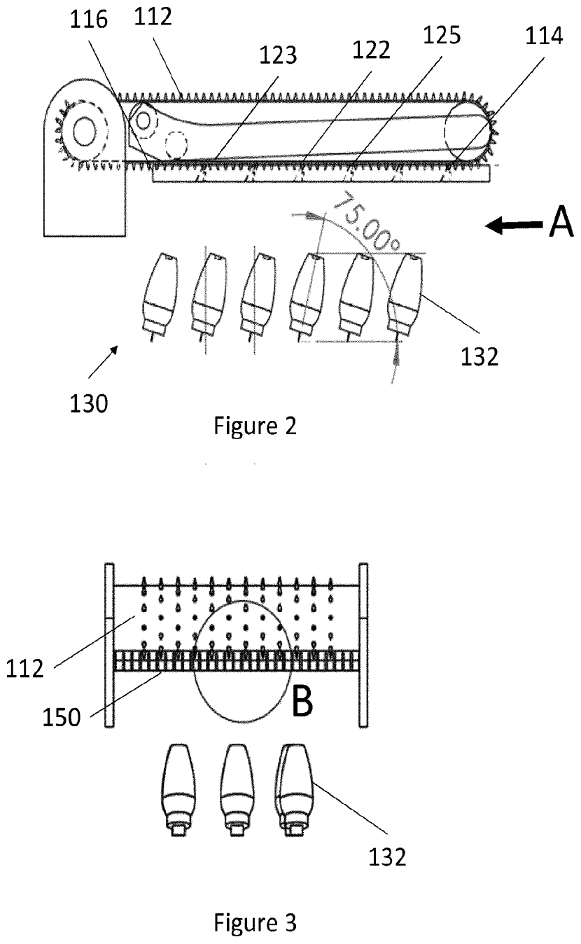

FIG. 2 shows a side view of a conveyor system and a fluid jetting system;

FIG. 3 shows a side view of a conveyor system and a fluid jetting system when viewed in the direction of arrow A in FIG. 2;

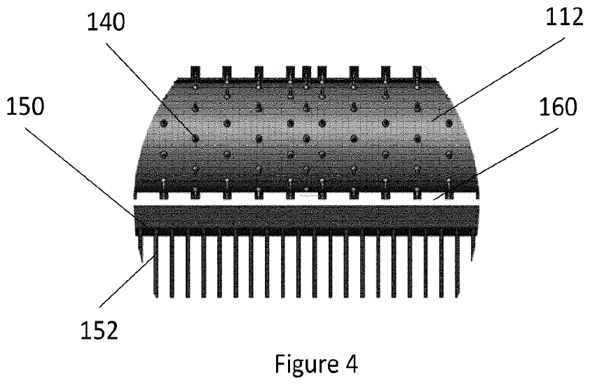

FIG. 4 shows a detailed view of the region B in FIG. 3;

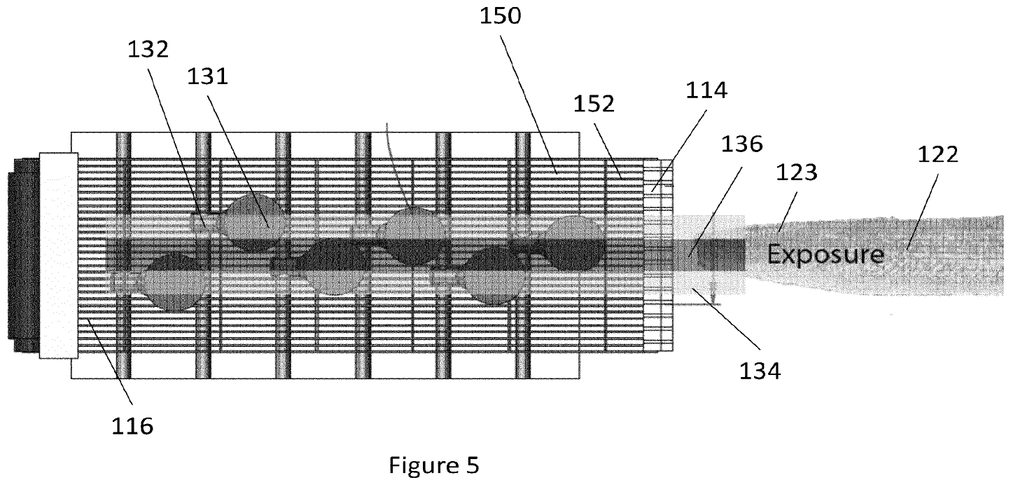

FIG. 5 shows a plan view of a conveyor system and a fluid jetting system;

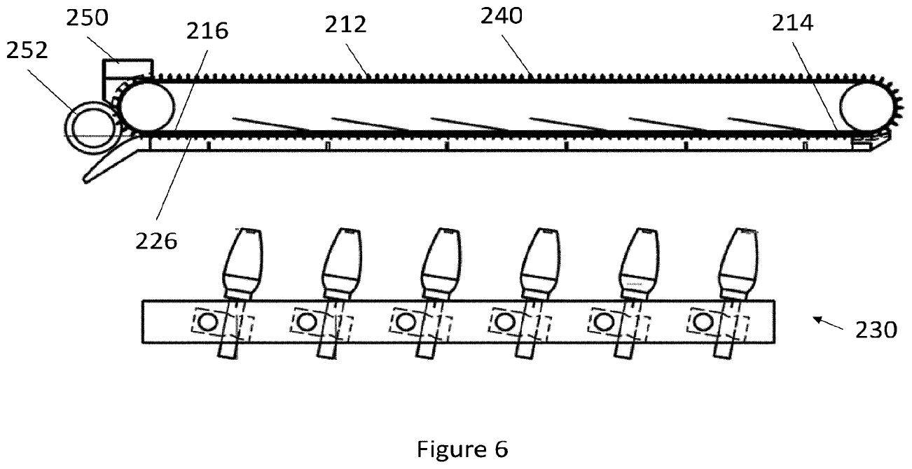

FIG. 6 shows a side view of a conveyor system and a fluid jetting system; and

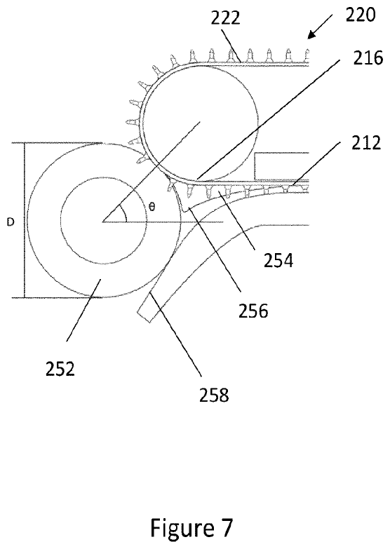

FIG. 7 shows a schematic of a conveyor system and exemplary detachment mechanism. The Figures, as discussed in more detail below, show examples of systems for producing descaled fish skins with the major part of the flesh also removed. When considering such systems it is important to understand the commercial prospects. With most fish products such as salmon, which is widely farmed, the primary fillet products comprise typically less than 50% of the fish, leaving a large and heterogeneous mixture of residuals, including viscera, trimmings, frame, head, bones, and skin. To increase the value, it would be highly beneficial to separate not only these primary fractions, but further isolate subcomponents to be able to utilise and appreciate their individual properties.

By way of example, collagen, a highly priced protein within the nutraceutical and cosmeceutical industry, is mostly found in the skin as well as in fish scales and bone.

Without pre-enrichment of those fractions, particularly the skin, it is very cumbersome and costly to extract collagen of sufficient purity and quality.

During fillet production, the skin is removed in a process called deep skinning and can be easily separated from the fillet processing line. However, this crude skin preparation is a complex biological structure with several layers of different biochemical composition.

On the outside a fish is protected by a layer of stiff scales made of calcium salts (hydroxyapatite) and collagen, encasing the fish in a flexible armour. In the example of salmon the scales are 3 to 5 mm wide. These scales sit deeply embedded in the dermal layer of the skin protruding from the epidermis and they are difficult to scrape off without causing damage to the underlying tissue.

Beneath the scales, the bulk part of the skin is comprised of a relatively thin, but highly flexible and tough layer of connective tissue. In full grown salmon this is typically in the range of 1.5 to 3 mm thick. Salmon skin is in fact one of the strongest animal skin types available. Relative to its thickness, it is stronger than the skin of most land animals, and the softness and sophisticated patterns makes it highly attractive in the fashion industry for use in bags, wallets, even ties.

The connective tissue is highly enriched in collagen, constituting up to 70% of its dry weight, depending on fish type and age. Collagen is a trimeric protein characterised by sharp bends created by glycine-hydroxyproline dimers and a helical structure, providing the skins unique properties of high tensile strength as well as flexibility.

In addition to being an attractive source of collagen, the skin is used in sophisticated food products like sushi, and dried and fried fragments of fish skin have been shown to have a great potential as a very tasty and healthy snack.

Beneath the connective tissue follows the thick muscle layer (the flesh), giving rise to the fillet products. When a fish is processed as described above (deep skinning), a considerable amount of muscle tissue remains attached to the skin, comprising ⅔ to ¾ by weight of the crude skin by-product, depending on the processing setup.

For salmon this immediate sub-skin muscle layer may contain more than 50% lipids (fat), compared to about 10 to 15% in average fillet tissue. While the specific biochemical composition may vary depending on e.g. the feed regime, water temperature or season, it is interesting that these lipids typically have a very high content of poly-unsaturated fatty acids, (according to the inventor's measurements about 13%, compared to 3% average in a fillet tissue), and could give rise to a valuable oil with unique properties. The isolated protein fraction could be used directly or processed further, for instance by enzymes. Protein hydrolysates are in demand in the food and feed industries, for instance in sports and heath drinks and other protein-enriched food products.

Thus, to increase the utility and value of the crude skin residual, these three fractions; the scales, the connective tissue and the sub-skin muscular layer need to be separated. The challenge is to separate the very tightly associated tissue layers without reducing the quality of the individual fractions. As already mentioned, mechanical scraping of the scales can easily damage the connective tissue preventing the skin from use in for instance high-end leather products, a growing market for fish skin.

As noted above, the inventors have realised that a significant barrier for mechanical handing of fish skin is its lack of rigidity. Even with muscle tissue attached the crude skin is very flexible, and it is difficult to keep it fixed in position during mechanical processing. Moreover, when the meat is removed, the surface of the connective tissue is very sticky. Finding solutions to these practical problems are particularly demanding when the objective is high-capacity continuous processing.

FIG. 1 shows an apparatus addressing this need, and being for removing scales from defleshed fish skin 122. In a descaling module 100, defleshed fish skin 122 comprising fish skin and scales is received by a conveyor system 110 at an entry end 114.

The conveyor system 110 comprises a rotating belt which forms a descaling surface 112. The defleshed fish skin 122 is held against the descaling surface 112 with the scaled surface of the defleshed fish skin 122 facing away from the descaling surface 112. It is therefore the scaled surface of the defleshed fish skin 122 which is exposed to the region beneath the conveyor system 110. The descaling surface 112 forms a single continuous loop which rotates along a corresponding continuous looped path. On the uppermost length of the looped path the descaling surface 112 moves from the exit end 116 of the conveyor system to the entry end 114 of the conveyor system 110. Accordingly, on the lowermost length of the looped path the descaling surface 112 travels from the entry end 114 to the exit end 116 of the conveyor system 110. The defleshed fish skin 122 is held against the descaling surface 112 as it travels along the lower most length of the looped path. The movement of the descaling surface 112 thereby transports the defleshed fish skin 122 from the entry end 114 to the exit end 116 of the conveyer system 110.

The descaling surface 112 comprises spikes 140, which protrude outwards in the direction away from the centre of rotation of the descaling surface 112. The spikes 140 extend between 2 and 10 mm from the descaling surface, optionally 4-7 mm 112 so that they penetrate the skin and extend fully across the gap between the descaling surface retention device 122. The spikes 140 that penetrate the defleshed fish skin 122 help to maintain the defleshed fish skin 122 in a suspended state as it travels from the entry end 114 to the exit end 116 of the conveyor system 110, as well as inhibiting movement of the defleshed fish skin 122 when forces are applied during descaling. The spikes 140 provide support for the defleshed fish skin 122 against the pressure of the jets of fluid.

A fluid jetting system 130 is arranged beneath the lowermost length of the descaling surface 112. As the defleshed fish skin 122 is transported from the entry end 114 to the exit end 116 the scaled surface of the defleshed fish skin 122 is exposed to the fluid jetting system 130 so that descaling of the defleshed fish skin can be carried out. The scales are removed by subjecting the defleshed fish skin 122 to the action of high-pressure water jets which create high shear forces on the skin surface. The water pressure of the jets is between 40 and 110 bar, preferably 90 bar. A pressure of this type may be used with a distance of 12 cm from the nozzle 132 orifice to the descaling surface 112. A plurality of nozzles 132 each provide a jet of fluid directed at the lowermost length of the descaling surface 112. In the example shown in FIG. 1, there are six nozzles 132 providing fluid jets against the descaling surface 112 as it travels along the lowermost length of the looped path. A higher or lower number of nozzles 132 may alternatively be used. The performance of the fluid jets can be optimised by altering the fluid pressure, the spraying diameter and the distance from the nozzles 132 to the defleshed fish skin 122. The fluid jets may be pulsed so that fluid is not continually exiting the nozzles 132. Pulsing reduces water consumption. The nozzles 132 may be configured to cause the fluid jets to rotate and/or oscillate so that a set of differently angled and pulsing shear forces are applied to the defleshed fish skin 122 to aid in removal of the scales. Alternatively, the nozzles 132, or parts thereof such as fluid channels in the nozzles 132, may be configured to rotate to thereby generate rotating fluid jets. Rotating fluid jets may allow for a lower pressure to be used whilst maintaining the efficiency of the scale removal process, thus a gentler scale removal process can be achieved.

A retention device 150 is disposed between the descaling surface 112 and the fluid jetting system 130. This described in more detail below with reference to FIG. 4.

The defleshed fish skin is introduced onto the descaling surface so that the longitudinal length of the defleshed fish skin aligns with the direction of travel of the descaling surface. When the tail end of the defleshed fish skin is forwardmost on the descaling surface in the direction of travel, the nozzles of the fluid jetting system are arranged at an angle between 10 and 30 degrees with respect to the vertical direction and towards the entry end 114 of the conveyor system. For example, the nozzles may be angled at 75 degrees from horizontal (15 degrees from vertical) as shown in FIG. 2. Different angles can be used, such as 80 degrees from horizontal (10 degrees from vertical). As explained above the angle of attack of the leading edge of the spray pattern is relevant, so the nozzle angle may vary depending on the angle of spread of the spray pattern. Thus, the fluid jetting system many be configured so that the leading edge of the spray from the jet may impact the fish skin at 20-60 degrees to the vertical, such as by having a 30 degree angle for the leading edge. As noted above this can be provided by different combinations of the nozzle angle and the spray pattern. In some examples, the leading edge of the fluid jets impact the horizontal defleshed fish skin 122 at an angle of between 25 to 40 degrees to the vertical.

With the tail end of the defleshed fish skin 122 oriented forwardmost, the fluid jets will impact on the scales from behind. That is, with the connection between the scales and the dermis of the skin towards the head end of the fish, and the remaining scale lying against the skin as it extends rearwards, the jets of fluid are angled to hit the skin underneath the rearward extension of the scale and towards the connection between the scale and the skin. This enables the removal of the scale from the dermis layer in a gentle manner.

The fluid and the removed scales fall from the defleshed fish skin 122 and the descaling surface 112 into a reservoir 170 positioned beneath the fluid jetting system. The reservoir may be arranged for separation of the scales from the fluid so that the scales can be collected and so that fluid can be recirculated back to the jets. There may be a sieving and/or filtering system to ensure a suitably clean fluid is recirculated.

At the exit end 116 of the conveyor system 110, the removal of the descaled and defleshed fish skin 126 from the descaling surface 112 is assisted by the curvature of the descaling surface 112 as it travels around the curved end of the conveyor system towards the uppermost length. As the descaling surface 112 curves away from the length of the descaled and defleshed fish skin 126 the descaled and defleshed fish skin 126 begins to detach. An additional detachment mechanism may be employed to assist in the removal of the descaled and defleshed fish skin 126 from the descaling surface 112. Examples of the detachment mechanism are further described below with reference to FIG. 6 and FIG. 7.

The descaled defleshed fish skin 126 enters a cleaner and/or dryer 180 where it is further processed.

The apparatus further includes a deskinning module 190. Fish skin with attached flesh 120 is positioned on a first conveyor belt 192 tail-end first. The first conveyor transports the fish skin with attached flesh 120 to a knife 194 which precisely removes the flesh from the skin. The flesh 124 is transported via a second conveyor 196 to be removed from the system and collected for further processing or to be used for alternative purposes. The defleshed fish skin 122 comprising the connective tissue and the scales is transported via a third conveyor 198 to the descaling module 100.

FIG. 2 shows a side view of the conveyor system 110 and the fluid jetting system 130. The nozzles 132 are disposed at different positions along the length of the descaling surface 112. In this example the nozzles 132 are oriented at an angle of 75 degrees from the horizontal, as shown. The centre lines of the fluid jets therefore impact the descaled fish skin 122 at an angle of 15 degrees from the vertical. The leading edge of the spray pattern will impact at a larger angle from the vertical, dependent on the angle of spread of the spray. For example a spray that spreads at ±15 degrees from the centre line would give a leading edge that impacts the defleshed fish skin 122 at an angle of 30 degrees from the vertical.

The tail end 123 of the defleshed fish skin 122 is ahead on the conveyor as the conveyor transports the defleshed fish skin 122 from the entry end 114 to the exit end 116. The fluid jets therefore impact the scaled surface of the defleshed fish skin 122 in the opposite direction to the direction of extension of the scales from the connecting point between the scales and the skin. The fluid jets can access the underneath of the scales, and the connecting point between the scales and the skin. This is beneficial for removing the scales whilst causing limited damage to the skin.

The nozzles 132 are capable of rotating so that the angle at which the fluid jets impact the defleshed fish skin 122 can be altered in order to optimise the angle of impact. For example, the optimal angle of impact may depend on parameters such as the type of fish skin, the size of the scales, the pressure of the fluid jets, the length of the descaling surface, etc. The optimal angle will also depend on whether rotating jets are being used.

If the defleshed fish skin 122 is placed on the descaling surface 112 with the head end 125 first and the nozzles 132 are configured as shown in FIG. 2, the fluid jets would impact the scaled surface of the defleshed fish skin 122 in the direction of extension of the scales from the connecting point between the scales and the skin. The direction of the fluid jets will cause the scales to lie flat against the skin and the fluid jets will not impact the connection between the scales and the skin to have the desired loosening effect. In this situation the nozzles 132 can instead be rotated so that the fluid jets are directed in a forwards direction relative to the direction of movement of the defleshed fish skin 122. The orientation of the nozzles 132 can be manually set in accordance with the expected/desired orientation of the defleshed fish skin 122. In some embodiments, the apparatus may include sensors which can detect the orientation of the defleshed fish skin 122. The nozzles 132 can then automatically rotate in response to the determined direction of the defleshed fish skin 112 such that the direction of the jets of fluid is always from the end of the scale towards the attachment point of the scale.

FIG. 3 is a side view of the conveyor system 110 and the fluid jetting system 130 when viewed along direction A shown in FIG. 2. It can be seen that the nozzles 132 are not disposed at the same horizontal position to form a single vertical line along the length of the descaling surface 112. The nozzles 132 are disposed at multiple different positions in the horizontal direction of the descaling surface 122 so that the entire surface of the defleshed fish skin 122 is impacted by fluid jets as it travels from the entry end 114 to the exit end 116 of the conveyer system 110.

FIG. 4 shows a detailed view of the area B in FIG. 3, including the retention device 150 and the descaling surface 112. The retention device is in the form of a grill 150 which comprises a series of parallel rods 152. The rods 152 are typically 2 mm or less in width and 20 mm in depth, and are arranged 20 mm apart from each other to form the grill 150. The grill 150 allows the scaled surface of the defleshed fish 122 to be supported whilst allowing the fluid jets from the fluid jetting system 130 beneath the retention device 150 to impact on the scaled surface of the defleshed fish skin 122.

The spikes 140 of the descaling surface 112 align with the spaces between the rods 152. Therefore, the spikes 140 pass unhindered through the grill 150 as the descaling surface 112 travels along the looped path.

As discussed above, it is important to consider the gap between the descaling surface 112 and the retention device 150, e.g. relative to the thickness of the defleshed fish skins 122 that are being processed. In this example, prior to use, the descaling surface 112 is lowered down towards the retention device 150, creating a small, optimised gap allowing the defleshed fish skin to pass, while maintaining the skin in a flat and fully outstretched configuration. Optionally, the descaling surface 112 is lowered fully onto the retention device 150, creating a mild pressure on the defleshed fish skin 122 as it passes due to the weight of the conveyor belt. In consequence the gap 160 between the descaling surface 112 and the retention device 150 becomes equal to the thickness of the defleshed fish skin 122, but only when a skin is present.

FIG. 5 shows a plan view of the descaling module with the conveyor system omitted. In particular, FIG. 5 shows the retention device 150, and the fluid jetting system 130 disposed beneath the retention device 150. In this example, the nozzles 132 has a spray angle of 15 degrees. Being located 12 cm from the descaling surface, they produce a spray diameter 131 of approximately 7 cm at the point of impact with the defleshed fish skin 122. None of the spray diameters 131 overlap with that of another nozzle 130. In some cases the spray diameter may be greater than or smaller than 7 cm depending on the nozzle design and distance to the descaling surface.

The nozzles 132 are arranged so that a high exposure zone 136 is established where there is overlap of the spray diameters 131 from each nozzle 132 in the direction of travel of the descaling surface 112. It is advantageous to let all parts of the skin be subjected to more than one fluid jet, as this will increase efficiency of the scale removal process and allow for a lower water pressure. As shown in FIG. 5, the entire surface of the defleshed fish skin 122 is subjected to at least three fluid jet as it travels from the entry end 114 to the exit end 116 of the conveyor system 110. A coverage zone 134 is illustrated to show the regions of the spray diameters 131 outside of the high exposure zone 136 but which will still impact on the defleshed fish skin 122.

FIG. 6 shows an embodiment of the descaling apparatus in which the exit end 216 of the conveyor system 210 is additionally modified to aid in removal of the descaled defleshed fish skin 226 from the descaling surface. The fluid jetting system 230 is also shown beneath the descaling surface 212.

The exit end 216 of the conveyor system 210 includes a scraper 250 which aids in the removal of the descaled defleshed fish skin 226 from the descaling surface 212. The scraper 250 presses against the descaling surface 212 forcing the descaling surface 212 away from the descaled defleshed fish skin 226 suspended on the spikes 240. A brush 252 comprising stiff bristles rotates and contacts the descaled defleshed fish skin 226 and correspondingly forces the descaled defleshed fish skin 226 away from the descaling surface 212. Alternatively, the rotating part does not comprise bristles and is instead a roller. In order to allow the descaling surface 212 to pass through the scraper 250, the scraper 250 includes slits which are aligned with the position of the spikes 240 on the descaling surface 212. There is therefore no contact between the scraper 250 and the spikes 240.

FIG. 7 schematically illustrates a detachment mechanism comprising a roller or brush 252 disposed beneath and at a tangent to the descaling surface 212, in this example there is no scraper 250 as in FIG. 6. The intersection of the centre of the roller or brush and the centre of the radius of curvature of the exit end 216 of the conveyor system may forms an angle θ of approximately 45 degrees to the vertical.

Static guides 254 are disposed at the exit end 216 of the descaling surface 212. The guides 254 are positioned and shaped so that as the descaled defleshed fish skin is moved towards the exit end 216 of the descaling surface 212 the descaled defleshed fish skin travels beneath the bottom surface 256 of the guide 254 and along an exit surface 258. Hence, the guides 254 are shaped so as to force the descaled defleshed fish skin away from the descaling surface 212, detaching it from the spikes and thus preventing the descaled defleshed fish skin from being retained against the conveyor system 220 as the belt moves around the exit end 216 and to the upper surface 222.

The descaled defleshed fish skin is then directed to travel between the roller or brush 252 and exit surface 258. The exit surface 258 is formed as an ending projection of the retention device 260 and supports the descaled defleshed fish skin as it leaves the fish processing apparatus.

These static guides may be suspended in position beneath the moving descaling surface 212 via a suitable support (not shown). In this example the guides would be located between the row of spikes almost touching the conveyer belt. Alternatively, they may be attached to the conveyer system itself. In this case, the descaling surface 212 may be split into two or more parallel sections such that the guides are accommodated within each of the one or more gaps between the parallel sections.

1. An apparatus for processing of fish products comprising a descaling apparatus for removing scales from defleshed fish skin, the descaling apparatus comprising:
a conveyor system for receiving defleshed fish skin, wherein the defleshed fish skin comprises skin and scales with a major part of the flesh removed;
a fluid jetting system;
a descaling surface for holding the defleshed fish skin with the scale side facing the fluid jetting system;
wherein the fluid jetting system directs jets of fluid under pressure toward the defleshed fish skin with the jets configured to impact the defleshed fish skin at an angle, in order to thereby bend and detach the scales; and
wherein the descaling surface and fluid jetting system are arranged for relative movement between the defleshed fish skin and the jets of fluid of the jetting system in order that the full area of the defleshed fish skin is exposed to the fluid jets.

2. An apparatus as claimed in claim 1, wherein the descaling surface is a conveying surface also forming a part of the conveyor system.

3. An apparatus as claimed in claim 1, wherein the descaling surface includes spikes for piercing and hence gripping the defleshed fish skin.

4. An apparatus as claimed in claim 3, wherein the spikes have an exposed length of 2 mm or more.

5. An apparatus as claimed in claim 1, wherein the descaling surface is configured so that the exposed surface of the defleshed fish skin faces in a downward direction, and wherein the fluid jetting system is arranged to direct the jets of fluid in an upward direction, angled to the surface of the defleshed fish skin.

6. An apparatus as claimed in claim 1, comprising a retention device for preventing the defleshed fish skins from detaching from the descaling surface during the descaling process.

7. An apparatus as claimed in claim 6, wherein the descaling surface is a downward facing descaling surface, and wherein the retention device extend parallel to the descaling surface and below the descaling surface so that the defleshed fish skin cannot fall away from the descaling surface without being caught by the retention device.

8. An apparatus as claimed in claim 6, wherein the descaling surface and the retention device are configured to provide a gap to receive the defleshed fish skin, and wherein when the device is in use the defleshed fish skin in the gap between the descaling surface and the retention device is subject to a compressive pressure.

9. An apparatus as claimed in claim 6, wherein the retention device is a grill comprising multiple parallel rods allowing for the jets of fluid to pass through the retention device toward the descaling surface, but preventing the defleshed fish skin from detaching from the descaling surface during the descaling process.

10. An apparatus as claimed in claim 9, wherein the parallel rods extend in the direction of the relative movement of the descaling surface and the fluid jetting system.

11. An apparatus as claimed in claim 1, wherein the angled jets of fluid rotate with an axis of rotation parallel to the direction of the jet.

12. An apparatus as claimed in claim 1, wherein fluid jetting system directs angled jets of fluid at the defleshed fish skin to remove the scales with the angled jets of fluid being angled in the tail to head direction to push the scales away from the defleshed fish skin.

13. An apparatus as claimed in claim 12, wherein centre-lines of the angled jets of fluid are angled at 5-40 degrees to the vertical, and wherein a spray pattern of the jets includes a spread of ±5-30 degrees around the centre-line of the spray.

14. An apparatus as claimed in claim 1, comprising a reservoir for receiving detached scales along with fluid from the jets after impaction on the descaling surface and/or defleshed fish skin.

15. An apparatus as claimed in claim 1, comprising sensors for determining the location and/or orientation of the defleshed fish skin at one or more points.

16. An apparatus as claimed in claim 1, comprising an automated system for controlling the relative movement of the defleshed fish skin and action of the fluid jetting system in order to modify the location and/or orientation of the fish skin to align it with the location, direction and action of the angled jets of fluid.

17. An apparatus as claimed in claim 1, comprising a release mechanism for removing the defleshed fish skin from the descaling surface, the release mechanism comprising one or more of:
i) a scraper,
ii) a brush,
iii) a roller,
iv) one or more guides, and
v) a skin release fluid jetting system.

18. An apparatus as claimed in claim 1, comprising a cutting device for receiving fish skin with attached flesh and for removing a major portion of the flesh to provide the defleshed fish skins, wherein the apparatus is arranged to convey the defleshed fish skins from the cutting device to the conveyor system of the descaling apparatus.

19. An apparatus as claimed in claim 18, wherein the cutting device comprises a cutter conveyor belt and a knife, wherein the knife is placed with its cutting edge extending across the width of the cutter conveyor belt and perpendicular to the direction of movement of the conveyor belt.

20. An apparatus as claimed in claim 19, wherein the knife is located with the entire length of the cutting edge spaced apart from the surface of the cutter conveyor belt by a distance of 3 mm or less, or optionally 2 mm or less.

21. A method for processing of fish products comprising using a descaling apparatus for removing scales from defleshed fish skin, the descaling apparatus comprising:
a conveyor system for receiving defleshed fish skin, wherein the defleshed fish skin comprises skin and scales with a major part of the flesh removed; a fluid jetting system; and a descaling surface for holding the defleshed fish skin with the scale side facing the fluid jetting system;
wherein the method comprises:
receiving defleshed fish skin at the conveyor system and conveying it to the descaling surface;
directing jets of fluid under pressure from the fluid jetting system toward the defleshed fish skin with the jets configured to impact the defleshed fish skin at an angle, in order to thereby bend and detach the scales; and
moving the defleshed fish skin relative to the fluid jetting system in order that the full area of the defleshed fish skin is exposed to the fluid jets.

22. (canceled)
